(19) United States
(12) Patent Application Publication
(10) Pub. No.: US 2025/0098580 A1
(43) Pub. Date: Mar. 27, 2025

(54) Straw Spreader for a Combine Harvester

(71) Applicant: AGCO do Brasil Soluções Agrícolas Ltda., Ribeirao Preto (BR)

(72) Inventor: Marcelo Carpenedo, Sapucaia do Sul (BR)

(21) Appl. No.: 18/883,451

(22) Filed: Sep. 12, 2024

(30) Foreign Application Priority Data
Sep. 26, 2023 (GB) 2314745.7

(51) Int. Cl. A01D 41/12

(52) U.S. Cl. CPC A01D 41/1243

(57) ABSTRACT

A straw spreader for a combine harvester has first and second rotary spinners for receiving MOG from an input and distributing the MOG from an outlet area. Each rotary spinner has a set of outwardly extending paddles each with a front face for directing material flow. Vanes are provided which project outwardly from the front face of the paddles and which extend in the outward direction. The vanes define channels which control the direction of material flow off the spinner, so that the output distribution is more uniform and constant.

### FIELD

This application claims the benefit of the filing date of U. K. Provisional Patent Application 2314745.7, “A Straw Spreader for a Combine Harvester,” filed Sep. 26, 2023, the entire disclosure of which is incorporated herein by reference.

Embodiments of the present disclosure relate generally to combine harvesters, and in particular to a straw spreader used within a combine harvester.

### BACKGROUND

A combine harvester typically includes a threshing system for detaching grains of cereal from material other than grain, such as cobs, stems and seed pods, a separating apparatus downstream of the threshing system, and a grain cleaning apparatus (known as the cleaning shoe) for receiving grain from the separating apparatus. A stratification pan aims to stratify the material into a layered structure of grain at the bottom and light chaff and other material other than grain (MOG) at the top. The grain is collected in a grain bin, and from the grain bin the grain can be unloaded, for example to a trailer pulled by a tractor which runs alongside the combine harvester.

It is well known to install chaff spreaders for collecting and distributing MOG (i.e., chaff) ejected from the rear of the cleaning shoe. A chaff spreader for example comprises a pair of fan modules which eject the chaff at a tangent to a fan rotation axis.

It is also well known to install a straw chopper behind the threshing and separating apparatus for cutting straw, and to use a straw spreader to distribute the cut straw over the field. The straw spreader comprises rotary spinners (impellers) which drive the material into an output channel with a desired outlet direction. For example, a typical straw spreader has a pair of spinners, to actively accelerate the chopped straw and spread it at the back of the combine.

It is also known to enable the chaff from the chaff spreader to be fed into the straw chopper and/or straw spreader. For example, in a first mode, the chaff may be delivered to the straw chopper so that the chaff is spread together with the chopped straw, across the full cutting width. The straw spreading system provides a better distribution over the harvested field than a typical chaff spreader. In a second mode, a straw swath is formed, and the chaff spreader can be slowed down to mix the chaff with the straw swath to maximize the quantity and quality of straw. In a third mode, the chaff is spread before entering the straw chopper or spreader, by directing the chaff to the sides using deflectors.

In known straw spreaders, it is usually a challenge to achieve an even spread of material. Typically, there is a deflector that guides the outlet of material. This deflector may be stationary, or it may be movable to enable adjustment. However, in either case, the distribution may be uneven.

The impeller (known as the spinner) used typically comprises paddles which define simple smooth walls which are used to accelerate the material (e.g., straw or chaff) from a central portion (which is the region to which material is fed) to the border (which is the region of discharge). The longer the paddles, and the higher the spinner speed, the greater the energy imparted to the material and hence the distance over which the straw or chaff can be distributed.

Spinners with a smooth paddle surface drive the material outwardly but have no control over where the material is thrown. As a result, the output flow from the spinner depends on the input flow direction, which is also not tightly controlled. The directional control is instead implemented using deflectors positioned in the output flow from the spreader. However, different output flow directions from the spinner will still result in different flow distributions even after the outlet deflectors. Thus, it remains difficult to achieve a uniform distribution of MOG.

There is therefore a need for a straw spreader which can achieve a more uniform distribution of MOG but without adding significant complexity to the design.

### BRIEF SUMMARY

In one aspect, the invention is directed to a straw spreader for a combine harvester, including an inlet area for receiving MOG and first and second rotary spinners for receiving MOG from the input and distributing the MOG from an outlet area. Each rotary spinner is rotatable about a respective rotation axis and has a central hub and a set of paddles extending outwardly from the central hub to a periphery of the spinner, each paddle having a front face for directing material flow. Vanes are provided which project outwardly from the front face of the paddles and which extend in said outward direction. This spreader may be used for spreading chopped straw from a straw chopper but it may also be fed with chaff from a chaff spreader.

The vanes constrain the position of material on the paddles, so that the material remains within channels defined between the vanes. In this way the radially outward movement of the material generated by the rotating spinner follows a fixed path which is independent of the direction along which material is introduced into the spreader. The result is an output distribution which is more uniform and more independent of the output flow characteristics from a straw chopper or from a cleaning shoe.

The paddle front face is for example in a plane parallel to the rotation axis. Thus, the paddles extend straight along the rotation axis as well as radially outwardly towards the periphery. The vanes for example lie in a plane perpendicular to the rotation axis. Thus, they project normally from the front face and are parallel to each other, to define constant width radial channels between adjacent vanes. Each spinner for example comprises a base which lies in a plane perpendicular to the rotation axis, the central hub projects from the base, and a ramp surface is provided between the base and each paddle. This ramp surface directs material towards the paddles.

The invention also provides a combine harvester having a crop cutting head, a threshing and separating system; a straw chopper for cutting MOG received from the threshing and separating system; and the spreader defined above for receiving a straw flow from the straw chopper and distributing the cut straw.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 shows a combine harvester which may be adapted in accordance with the invention;

FIG. 2 shows one example of threshing system and grain cleaning apparatus in more detail;

FIG. 3 shows a conventional straw spreader, viewed from beneath;

FIG. 4 shows a conventional spinner used in a spreader;

FIG. 5 shows a spinner in accordance with an example of the invention; and

FIG. 6 shows an isometric view of the underside of a straw spreader using the spinners of the invention.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure provides a straw spreader for a combine harvester, having first and second rotary spinners for receiving MOG from an input and distributing the MOG from an outlet area. Each rotary spinner has a set of outwardly extending paddles each with a front face for directing material flow. Vanes are provided which project outwardly from the front face of the paddles and which extend in the outward direction. The vanes define channels which control the direction of material flow off the spinner, so that the output distribution is more uniform and constant.

This disclosure relates to the design of the spinner used in a combine straw spreader. However, a general outline of a combine harvester will first be provided.

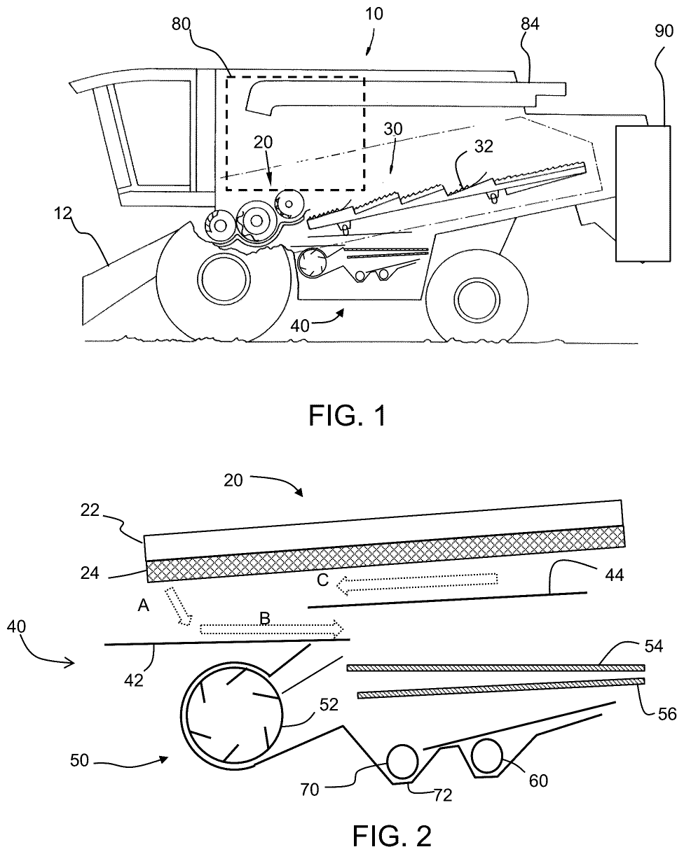

FIG. 1 shows a known combine harvester 10 to which the invention may be applied. The combine harvester includes a threshing system 20 for detaching grains of cereal from the ears of cereal, and a separating apparatus 30 which is connected downstream of the threshing system 20. The threshing system comprises one or more threshing units, in particular rotors, and associated concaves. In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

The grain cleaned by the grain cleaning apparatus is delivered to a grain bin 80 by a filling auger 70. Grain from the grain bin is removed from the combine harvester by an unloading tube 84.

The combine harvester has a front elevator housing 12 at the front of the machine for attachment of a crop cutting head (known as the header, not shown). The header when attached serves to cut and collect the crop material as it progresses across the field, the collected crop stream being conveyed up through the elevator housing 12 into the threshing system 20.

In the example shown, the threshing system 20 is a tangential-flow ‘conventional’ threshing system, i.e., formed by rotating elements with an axis of rotation in the side-to-side direction of the combine harvester and for generating a tangential flow. For example, the ‘conventional’ threshing system includes a rotating, tangential-flow, threshing cylinder and a concave-shaped grate. The threshing cylinder includes rasp bars (not shown) which act upon the crop stream to thresh the grain or seeds from the remaining material, the majority of the threshed grain passing through the underlying grate and onto a stratification pan (also sometimes known as the grain pan).

There are also axial threshing systems, i.e., formed by rotating elements with an axis of rotation in the longitudinal direction (direction of travel). For example, the threshing section may have axially-aligned rasp bars spaced around the front section whilst the separating section has separating elements or fingers arranged in a pattern, e.g., a spiral pattern, extending from the rasp bars to the rear of the rotor.

The MOG (material other than grain), in particular chaff, exits the combine harvester at the back. This invention relates to a chaff spreader 90 provided at the back of the combine harvester. As discussed above the chaff spreader may be used for spreading the chaff in a uniform layer over the harvested field, or it may be used to mix the chaff with straw, either for distribution or for mixing with a straw swath.

As mentioned above, instead of tangential flow threshing (and separating), axial threshing (and separating) is also known, and the invention may be applied to any type of combine. For completeness, FIG. 2 shows an axial threshing and separating system 20, together with a more detailed view of the cleaning apparatus 40.

The threshing system 20 in this case comprises an axial rotor 22 beneath which is mounted the concave 24. The concave may have different sections along its length, and the first section to receive the crop material (to the left in FIG. 2) may have a releasable concave, or else the whole length of the concave may be releasable. The separating function for this type of combine involves conveying the crop stream rearwardly in a ribbon passing along a spiral path.

No matter what type of threshing is performed, the initial threshing creates a flow of grain to a stratification pan 42. The separating function further downstream of the threshing system serves to separate further grain from the crop stream and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 does not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 is in the form of a grain cleaning unit 50. The grain cleaning unit 50 removes this unwanted material thus leaving a clean sample of grain to be delivered to the bin.

The grain cleaning unit 50 comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The general flow of material is as follows. The grain passing through the concave 24 falls onto the front of stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the concave further back falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and is conveyed as indicated by arrow B.

The combined crop streams thus progress rearwardly towards a rear edge of the stratification pan 42. Whilst conveyed across the stratification pan 42, the crop stream, including grain and MOG, undergoes stratification wherein the more dense grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the grain to pass through the chaffer onto an underlying second sieve 56.

The chaffer 54 is coarser (with larger holes) than second sieve 56. Grain passing through chaffer 54 is incident on the lower sieve 56 which is also driven in an oscillating manner and serves to remove tailings from the stream of grain before being conveyed to the on-board bin by the filling auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner. The grain is for example smaller and denser and generally more aerodynamic than MOG, therefore, less susceptible to being conveyed rearward by the chaffer/sieve and/or blown out of the rear of the machine by the air stream of the cleaning fan, passing upward and rearward, through the chaffer.

All material which has not been collected by the filling auger 70 or returns auger exits the back of the combine harvester and passes to a chaff spreader. The chaff spreader receives the rejected material from the cleaning shoe. It is also known to provide a straw chopper and straw spreader for the straw output by the separating apparatus, such as the straw walker. The chaff spreader and straw chopper and spreader are shown schematically in FIG. 1 as unit 90. This disclosure relates in particular to the design of the spinner which may be used in a straw spreader or chaff spreader.

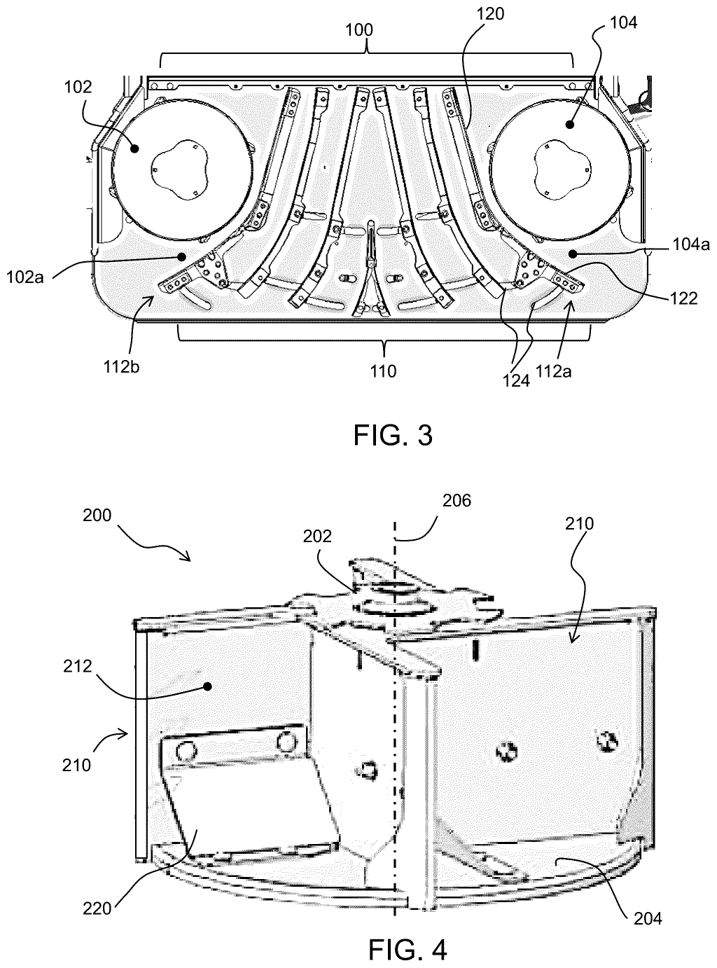

FIG. 3 shows a conventional straw spreader, viewed from beneath. The straw spreader is downstream of a straw chopper, which is not shown.

The straw spreader has an an inlet area 100 for receiving MOG, in particular chopped straw from a straw chopper, but it may also receive chaff from a chaff spreader downstream of the cleaning shoe of the combine. First and second rotary spinners 102, 104 are provided at opposite lateral sides of the straw spreader for receiving MOG from the input area 100 and distributing the MOG from an outlet area 110. The spinners 102, 104 rotate in opposite directions, to accelerate the straw and deliver it along an output channel 102a, 104a. Each output channel is defined by a respective deflector 112a, 112b.

Each of the deflectors 112a, 112b in this example has an inlet portion 120 and an outlet portion 122 (labelled only for the deflector 112a). The two portions are coupled by a hinge. The inlet portion is fixed but the angle between the two portions may be adjusted so that the direction faced by the outlet portion is adjustable. The deflector may be fixed in the chosen shape by fixing bolts. The adjustment of the shape is enabled by guide slots 124 which follow an arcuate path centered on the hinge point.

FIG. 3 also shows four further deflectors between the deflectors 112a, 112b, which define between them (and the outer deflectors 112a, 112b) five further channels. These provide a flow of material towards a central area, but without the assistance of the spinners. The central channel splits into two, so that there are six outlet channels between the deflectors 112a, 112b, and one laterally outermost flow channel for each of the spinners. The divider for the central channel is also adjustable, so that the angle between the two ramp surfaces in the center can be adjusted.

The four further deflectors may also be adjusted. In the example shown, they pivot about their inlet end, and guide slots are again shown along which the deflectors are moved and clamped into their desired positions.

FIG. 4 shows a known example of a spinner 200 (used as the spinners 102, 104 in FIG. 3). The spinner 200 comprises a central hub 202 which extends upwardly (in the orientation shown) from a base 204. The spinner is driven to rotate about a rotation axis 206.

A set of paddles extends outwardly from the central hub to a periphery of the spinner. In the example shown, there are four paddles 210 but there may of course be a different number. Each paddle has a front face 212 for directing material flow. The rotation direction is thus with the front face moving forwards.

Ramp surfaces 220 are provided between the base 204 and each paddle 210. These push the material along the axial direction, in particularly upwardly. The spinner is orientated in the direction shown in FIG. 4 in use, namely with the base at the bottom, and hence the base is seen in the underside view of FIG. 3.

The ramp surfaces 220 are used to move the material upwardly to increase the material density, so that a wider spreading distance is achieved. The disc diameter and speed are factors that also influence the efficiency of the material spreading function.

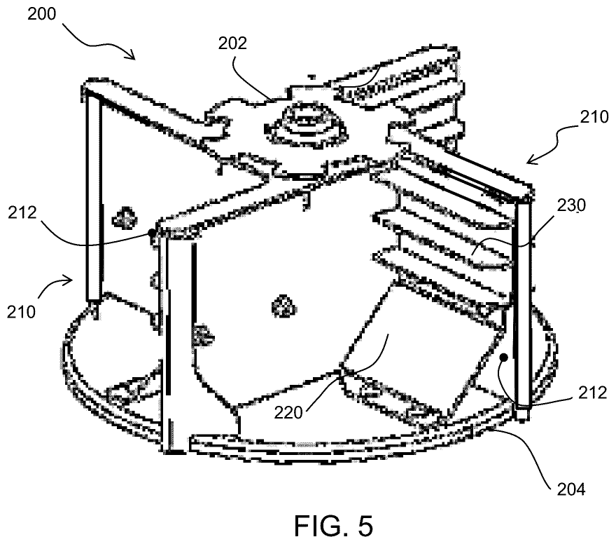

FIG. 5 shows a modification to the design of FIG. 4. The same parts are given the same reference numbers as in FIG. 4.

Vanes 230 are provided which project outwardly and forwardly (with respect to the direction of rotation) from the front faces 212 of the paddles. The vanes 230 extend in the outward direction, namely across the radial width of the paddles. The vanes 230 lie in a plane perpendicular to the rotation axis. Thus, they are parallel to the base and lie within a plane when rotated. The material delivered to the front faces is then constrained to remain within an individual channel (wherein channels are defined between adjacent vanes) while it is radially expelled from the spinner. This improves the consistency of the output distribution pattern as well as enabling a more uniform pattern (by suitable design of the vanes and any downstream deflectors).

In other examples, the vanes may slope relative to the base so that they impart an axial component of motion (i.e., a vertical component) rather than only a radial (horizontal) motion.

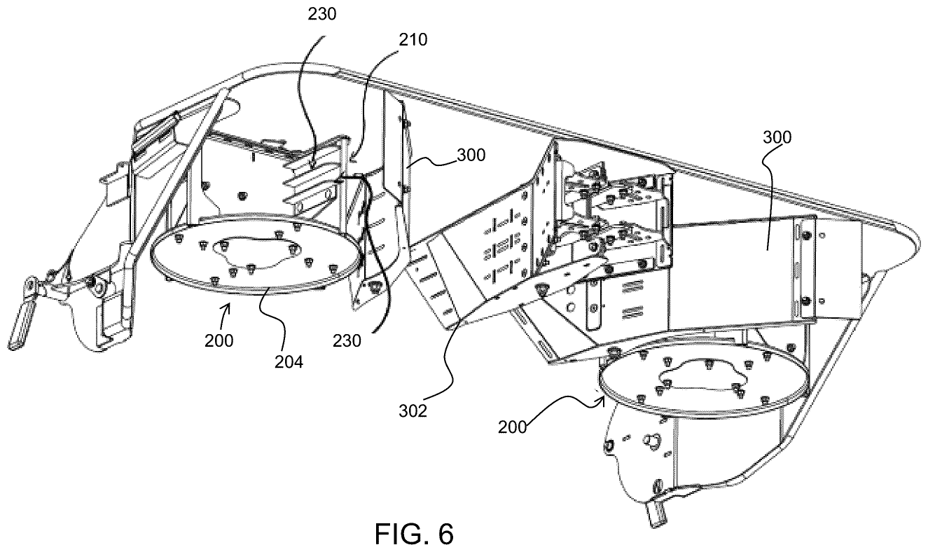

FIG. 6 shows an isometric view of the underside of a straw spreader using the spinners 200 of the invention.

The example shown has a deflector 300 for each spinner, and one central deflector 302 which divides the central flow stream (which does not pass through the spinners) into two flow channels. Again, the V-section where the flow direction is defined is adjustable.

The invention is for use as a straw spreader downstream of a straw chopper but it may be used also as a spreader for a combine chopped straw and chaff flow.

The example shown has three vanes on each front face. There may be a different number of vanes, such as between 2 and 10, or between 2 and 6. The vanes may extend in a continuous line along the full outward (i.e., radial) extent of the paddle front face as shown, but the vanes may instead be discontinuous and they may terminate before the outermost extremity of the paddle front face. The purpose is to create channels which impart a consistent flow outward flow direction from the paddle, and this may be achieved by shorter vanes.

The invention may be applied to any design of combine harvester. Thus, it does not rely on any particular threshing, separating or cleaning design, and the examples above are only given to aid overall understanding.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

All references cited herein are incorporated herein in their entireties. If there is a conflict between definitions herein and in an incorporated reference, the definition herein shall control.

What is claimed is:

1. A straw spreader for a combine harvester, comprising:
an inlet area for receiving MOG; and
first and second rotary spinners for receiving MOG from the input and distributing the MOG from an outlet area,
wherein each rotary spinner is rotatable about a respective rotation axis and comprises:
a base which lies in a plane perpendicular to the rotation axis,
a central hub which projects from the base; and
a set of paddles extending outwardly from the central hub to a periphery of the spinner, each paddle having a front face for directing material flow,
a ramp surface provided between the base and each paddle
wherein vanes are provided which project outwardly from the front face of the paddles, which extend in said outward direction and lie in a plane perpendicular to the rotation axis.

2. The straw spreader of claim 1, wherein the paddle front face is in a plane parallel to the rotation axis.

3. The straw spreader of claim 1 wherein each rotary spinner comprises a set of four paddles.

4. A combine harvester comprising:
a crop cutting head;
a threshing and separating system;
a straw chopper for cutting MOG received from the threshing and separating system; and
the straw spreader of claim 1 for receiving a straw flow from the straw chopper and distributing the cut straw.
